(19) United States
(12) Patent Application Publication
(10) Pub. No.: US 2018/0201231 A1
(43) Pub. Date: Jul. 19, 2018

(54) FOREIGN SUBSTANCE REMOVAL CONTROL DEVICE

(71) Applicant: DENSO TEN Limited, Kobe-shi (JP)

(72) Inventors: Yasushi TANI, Kobe-shi (JP); Junji HASHIMOTO, Kobe-shi (JP); Tomohide KASAME, Kobe-shi (JP); Teruhiko KAMIBAYASHI, Kobe-shi (JP); Nobunori ASAYAMA, Kobe-shi (JP); Nobuhisa IKEDA, Kobe-shi (JP); Takashi KONO, Kobe-shi (JP)

(73) Assignee: DENSO TEN Limited, Kobe-shi (JP)

(21) Appl. No.: 15/873,262

(22) Filed: Jan. 17, 2018

(30) Foreign Application Priority Data
Jan. 18, 2017 (JP) 2017-007083
Jan. 18, 2017 (JP) 2017-007084
Jan. 18, 2017 (JP) 2017-007085

(51) Int. Cl. B60S 1/56; H04N 5/247; G06T 7/00; B60S 1/52; B60S 1/54

(52) U.S. Cl. CPC B60S 1/56; H04N 5/247; G06T 2207/30252; B60S 1/52; B60S 1/54; G06T 7/0002

(57) ABSTRACT

There is provided a foreign substance removal control device including: an image recognizer having a processor and that detects foreign substance stuck on a lens of a camera based on an image captured by the camera; an injector that injects air or liquid to the lens of the camera; an output portion that outputs information to a user; and a controller that controls a foreign substance removal process for removing the foreign substance from the lens of the camera by causing the injector to inject the air or the liquid if the image recognizer detects the foreign substance stuck on the lens of the camera, in which the controller causes the output portion to output information which indicates that the foreign substance is stuck on the lens of the camera if the image recognizer detects the foreign substance stuck on the lens of the camera after the foreign substance removal process has been performed.

### BACKGROUND OF THE INVENTION

### Field of the Invention

The present invention relates to a foreign substance removal control device, a foreign substance removal control method, and a foreign substance removal control program.

### Description of the Background Art

There is a system which enables a vehicle's driver or the like to recognize a situation on the outside of the vehicle by displaying an image, which is captured by a camera installed on the outside of the vehicle, on a display such as a car navigation system inside the vehicle such as a passenger car. In addition, there is a system which performs white-line detection, stationary object detection, approaching object detection, and the like using the image which is captured by the camera installed on the outside of the vehicle.

In a case where foreign substance, such as raindrops, mud, or snow, is stuck on a lens (surface) of the camera installed on the outside of the vehicle, it is difficult to recognize the situation on the outside of the vehicle, and thus it is difficult to detect the white line or the like. Therefore, it is demanded to remove the stuck foreign substance (also referred to as an adhesive material). In a case where the foreign substance is stuck on the surface of the lens of the camera, a method for removing the foreign substance from the surface of the lens includes a method using a camera blower (which sprays compressed air to the lens), a washer (which splashes water on the lens), a camera wiper (which wipes the foreign substance using a wiper), or the like. In the most methods, the driver recognizes the foreign substance in the image captured by the camera and performs an operation of removing the foreign substance. Since the vehicle's driver is required to concentrate on driving of the vehicle, it is desired to remove the foreign substance stuck on the camera without the operation performed by the driver.

### SUMMARY OF THE INVENTION

According to an aspect of the present invention, there is provided a foreign substance removal control device including: an image recognizer having a processor and that detects foreign substance stuck on a lens of a camera based on an image captured by the camera; an injector that injects air or liquid to the lens of the camera; an output portion that outputs information to a user; and a controller that controls a foreign substance removal process for removing the foreign substance from the lens of the camera by causing the injector to inject the air or the liquid if the image recognizer detects the foreign substance stuck on the lens of the camera, in which the controller causes the output portion to output information which indicates that the foreign substance is stuck on the lens of the camera if the image recognizer detects the foreign substance stuck on the lens of the camera after the foreign substance removal process has been performed.

It is possible to remove the foreign substance stuck on the camera installed in the vehicle or the like.

In addition, according to another aspect of the present invention, there is provided a foreign substance removal control device including: an image recognizer having a processor and that detects foreign substance stuck on lenses of a plurality of cameras which are mounted on a vehicle based on images captured by the plurality of cameras; injectors that are provided to each of the plurality of cameras, and that inject air or liquid to the lenses of the plurality of cameras; an output portion that outputs information to a user; and a controller that controls a foreign substance removal process for removing the foreign substance from the lenses of the cameras by causing the injectors of the plurality of cameras to inject the air or the liquid in a case where the image recognizer detects the foreign substance stuck on the lenses of the plurality of cameras, in which the controller causes the output portion to output information which indicates that the foreign substance is stuck on the lenses of the plurality of cameras in a case where the image recognizer detects the foreign substance stuck on the lenses of the plurality of cameras after the foreign substance removal process has been performed.

It is possible to remove the foreign substance stuck on the plurality of cameras installed in the vehicle or the like.

Therefore, an object of the invention is to remove the foreign substance stuck on the camera installed in the vehicle or the like.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating an example of a configuration of a system which includes a foreign substance removal control device according to an embodiment.

FIG. 2 is a diagram illustrating an example of disposition of a camera, a blower, and a washer.

FIG. 3 is a diagram illustrating an example of hardware configuration of an information processing device.

FIG. 4 is a flowchart illustrating a first example of flow of a foreign substance removal operation in the camera installed in a vehicle.

FIG. 5 is a flowchart illustrating a second example of flow of the foreign substance removal operation in the camera installed in the vehicle.

FIG. 6 is a flowchart illustrating a third example of flow of the foreign substance removal operation in the camera installed in the vehicle.

### DESCRIPTION OF THE EMBODIMENTS

Hereinafter, embodiments will be described with reference to the accompanying drawings. Configurations of the embodiments are only examples, and a configuration of the present invention is not limited to detailed configurations of the disclosed embodiments. The detailed configurations according to the embodiments may be appropriately used in a case where the present invention is realized.

### EMBODIMENT

### Configuration Example

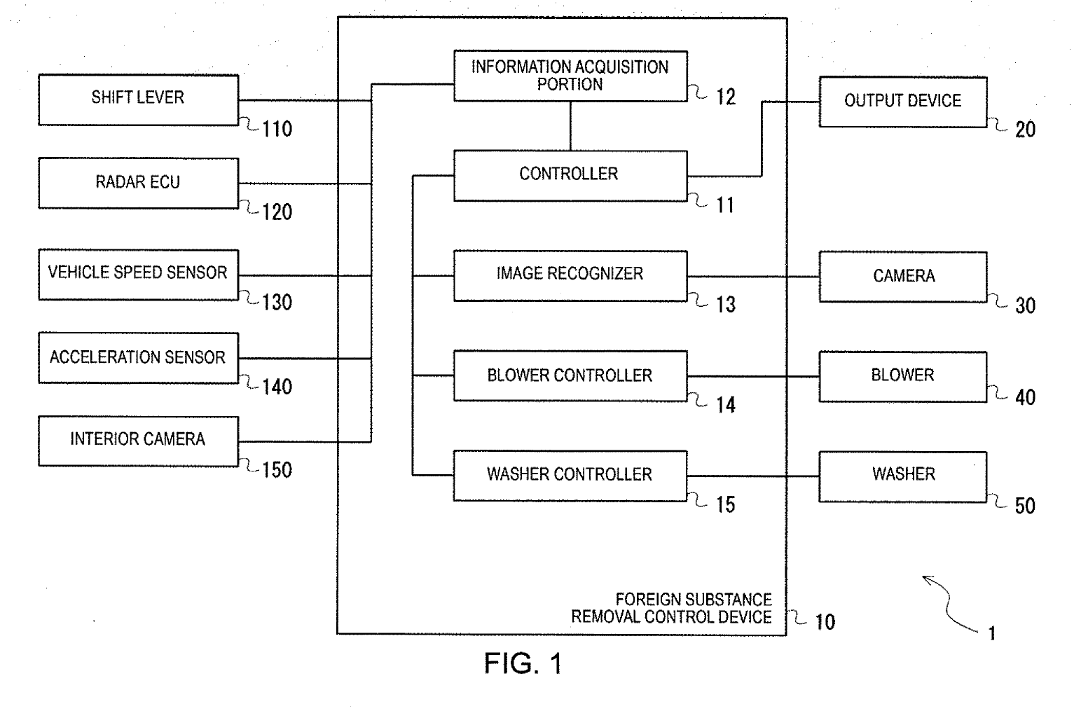

FIG. 1 is a diagram illustrating an example of a configuration of a system which includes a foreign substance removal control device according to an embodiment. A system 1 illustrated in FIG. 1 is mounted on a vehicle, such as a passenger car, and includes a foreign substance removal control device 10, an output device 20, a camera 30, a blower 40, and a washer 50. The foreign substance removal control device 10 controls removal of a foreign substance stuck on a surface of the camera 30 mounted on the outside of the vehicle using the blower 40, the washer 50, and the like. The foreign substance includes raindrop, mud, snow, and the like. The foreign substance removal control device 10 according to the embodiment includes a controller 11, an information acquisition portion 12, an image recognizer 13, a blower controller 14, and a washer controller 15. In addition, the foreign substance removal control device 10 is connected to a shift lever 110, a radar ECU 120, a vehicle speed sensor 130, an acceleration sensor 140, and an interior camera 150 of the vehicle. In addition, the foreign substance removal control device 10 is connected to the output device 20, the camera 30, the blower 40, and the washer 50. The blower 40 is an example of an air injecting section. The washer 50 is an example of a liquid injector.

The controller 11 is a control part that performs a calculation process for performing a foreign substance removal. The controller 11 acquires information or the like relevant to a vehicle on which the foreign substance removal control device 10 is mounted using the information acquisition portion 12. The controller 11 detects foreign substance, which is stuck on a lens of the camera 30, based on an image captured by the camera 30, which is installed on the outside of the vehicle, using the image recognizer 13. The controller 11 removes the foreign substance, which is stuck on the lens of the camera 30, by causing the blower controller 14 and the washer controller 15 to use the blower 40 and the washer 50. The controller 11, the blower controller 14, and the washer controller 15 may be integrated and may operate as one controller. In addition, the controller 11, the information acquisition portion 12, the image recognizer 13, the blower controller 14, and the washer controller 15 may be integrated and may operate as one controller.

The information acquisition portion 12 acquires information such as a state or the like of the vehicle on which the foreign substance removal control device 10 is mounted. The information acquisition portion 12 acquires a position of a shift lever from the shift lever 110, an object detection state from the radar ECU 120, a speed of the vehicle from the vehicle speed sensor 130, acceleration of the vehicle from the acceleration sensor 140, a driver's sight line direction from the interior camera 150, and the like. The information acquired by the information acquisition portion 12 is not limited thereto. The information acquisition portion 12 may acquire internal and external temperatures of the vehicle using a temperature sensor installed in the vehicle and internal and external noise levels of the vehicle using a microphone installed in the vehicle. The information acquisition portion 12 may be connected to a controller of the vehicle and may acquire the information. The information acquisition portion 12 stores the acquired information in a storage part.

The image recognizer 13 acquires an image captured by the camera 30 installed on the outside of the vehicle. The image recognizer 13 detects the foreign substance, which is stuck on the lens of the camera 30, based on the image captured by the camera 30. The image recognizer 13 detects the foreign substance, which is stuck on the lens of the camera 30, using a well-known image recognition technology. Specifically, the image recognizer 13 may detect a location of the foreign substance stuck on the lens, a type of the foreign substance, and the like. For example, the image recognizer 13 detects an object, which exists in the same location for a predetermined period in the captured image, as the foreign substance stuck on the lens. In addition, for example, the image recognizer 13 specifies the type of the foreign substance according to a color of the object detected as the foreign substance.

The blower controller 14 controls injection of compressed air with respect to the blower 40 installed around the camera 30. The blower 40 is capable of injecting the compressed air on the surface of the lens of the camera 30. The blower controller 14 controls the amount and a period of the compressed air which is injected from the blower 40.

The washer controller 15 controls injection of liquid, such as water or cleaning liquid, with respect to the washer 50 installed around the camera 30. The washer 50 is capable of injecting the liquid, such as water or cleaning liquid, on the surface of the lens of the camera 30. The washer controller 15 controls the amount and a period of the liquid, such as water or cleaning liquid, which is injected from the washer 50.

The output device 20 outputs the image or the like which is captured by the camera 30. The output device 20 includes a display, a speaker, and the like. A display or the like of a car navigation system, which is mounted on the vehicle, may be used as the output device 20. The display is installed in a location which can be viewed from a driver's seat of the vehicle.

The camera 30 is a capturing part that is installed on the outside of the vehicle and captures a situation around the vehicle. The camera 30 includes the lens, and the surface of the lens is exposed to outside air. Accordingly, for example, if it rains around the vehicle, raindrops may be stuck on the surface of the lens. A plurality of cameras 30 may be installed in the vehicle.

The blower 40 is installed around the camera 30, and injects compressed air on the surface of the lens of the camera 30 based on an instruction of the blower controller 14. The blower 40 includes an injection nozzle which is a compressed air injection port. A tip of the injection nozzle faces the surface of the lens of the camera 30. The blower 40 includes a tank that stores the compressed air, and a pump that injects the compressed air. The pump causes the compressed air to be sucked from the tank and to be injected from the injection nozzle.

The washer 50 is installed around the camera 30, and injects the liquid, such as water and cleaning liquid, on the surface of the lens of the camera 30 based on an instruction of the washer controller 15. The washer 50 includes an injection nozzle which is a liquid injection port. A tip of the injection nozzle faces the surface of the lens of the camera 30. The washer 50 includes a tank that stores the liquid, and a pump that injects the liquid. The pump causes the liquid to be sucked from the tank and to be injected from the injection nozzle.

The blower 40 and the washer 50 are installed for every camera 30. The blower 40 and the washer 50 are installed in locations which are not photographed in the image captured by the camera 30. The blower 40 and the washer 50 may be integrated. Furthermore, the camera 30, the blower 40, and the washer 50 may be integrated.

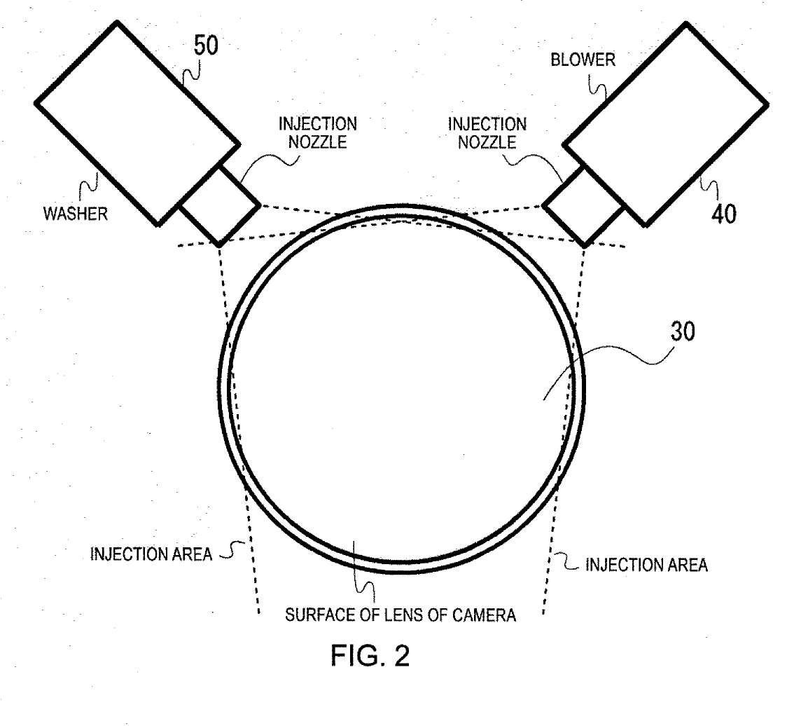

FIG. 2 is a diagram illustrating an example of disposition of the camera, the blower, and the washer. As illustrated in FIG. 2, the blower 40 and the washer 50 are disposed around the surface of the lens of the camera 30. Injection areas of the blower 40 and the washer 50 include almost entire surface of the lens. In addition, the injection nozzles of the blower 40 and the washer 50 may be movable and may be capable of injecting the compressed air and the liquid to a specified area. The blower 40 and the washer 50 may be integrated by standardizing the injection nozzles.

The shift lever 110 is a lever which changes gears or the like of the vehicle. For example, if the shift lever 110 is at the “R (reverse)” position, the vehicle moves backward. The position of the shift lever 110 is acquired by the information acquisition portion 12.

The radar ECU 120 is an electric controller that detects an object around the vehicle and calculates a distance or the like between the object around the vehicle and the vehicle. The radar ECU 120 calculates the distance or the like between the object and the vehicle using microwaves and the image captured by the camera 30 or the like. It could be difficult to accurately detect the object if the foreign substance is stuck on the camera 30.

The vehicle speed sensor 130 is a sensor that detects a running speed of the vehicle. For example, the vehicle speed sensor 130 detects and outputs a speed based on an angle of rotation of a tire, a radius of the tire, and the like.

The acceleration sensor 140 is a sensor that detects and outputs the acceleration of the vehicle.

The interior camera 150 is a camera that captures an interior of the vehicle. For example, the interior camera 150 detects a vehicle driver's sight line direction.

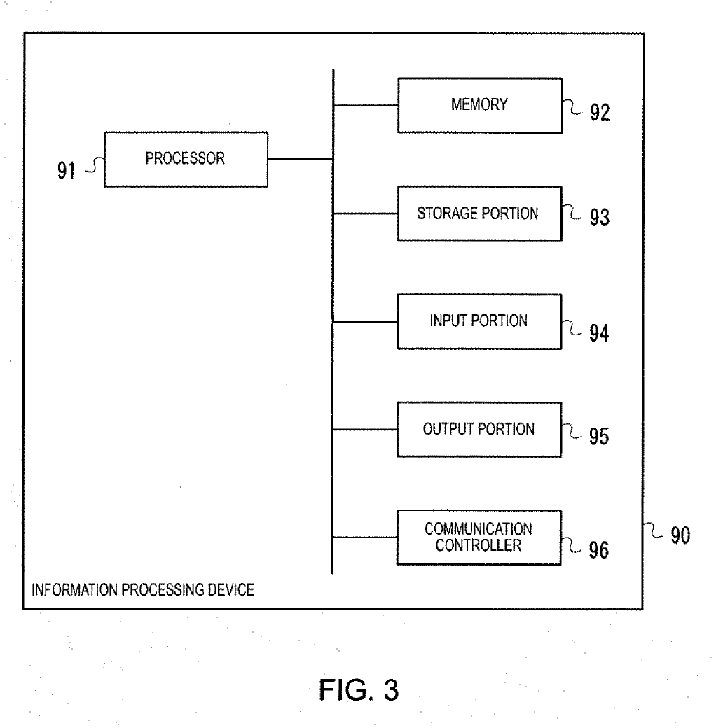

FIG. 3 is a diagram illustrating an example of hardware configuration of an information processing device. An information processing device 90 illustrated in FIG. 3 has a general configuration of a computer. The foreign substance removal control device 10 is realized using the information processing device 90 as illustrated in FIG. 3. The information processing device 90 of FIG. 3 includes a processor 91, a memory 92, a storage portion 93, an input portion 94, an output portion 95, and a communication controller 96. These portions are connected to each other through a bus. The memory 92 and the storage portion 93 are computer-readable recording media. The hardware configuration of the information processing device is not limited to the example illustrated FIG. 3, and the components may be appropriately omitted, replaced, and added.

It is possible for the information processing device 90 to realize functions matching a predetermined object in such a way that the processor 91 loads a program stored in a recording medium to a work area of the memory 92 and respective components are controlled through execution of the program.

For example, the processor 91 includes a Central Processing Unit (CPU) and a Digital Signal Processor (DSP).

For example, the memory 92 includes a Random Access Memory (RAM) and a Read Only Memory (ROM). The memory 92 is also referred to as a main storage device.

For example, the storage portion 93 includes an Erasable Programmable ROM (EPROM) and a Hard Disk Drive (HDD). In addition, the storage portion 93 may include a removable media, that is, a portable recording medium. For example, a removable media is a disc recording medium such as a Universal Serial Bus (USB) memory, a Compact Disc (CD), or a Digital Versatile Disc (DVD). The storage portion 93 is also referred to as a two-dimensional storage device.

The storage portion 93 stores various programs, various data, and various tables in the recording medium to be freely read and written. In the storage portion 93, an Operating System (OS), the various programs, and the various tables are stored. Information stored in the storage portion 93 may be stored in the memory 92. In addition, information stored in the memory 92 may be stored in the storage portion 93.

The operating system is software that intermediates software and hardware, manages a memory space, manages a file, and manages a process and a task. The operating system includes a communication interface. The communication interface is a program that exchanges data with another external device or the like connected through the communication controller 96. For example, the external device or the like includes another information processing device, an external storage device, and the like.

The input portion 94 includes a keyboard, a pointing device, a wireless remote controller, a touch panel, and the like. In addition, the input portion 94 may include a video and image input device, such as the camera, and a voice input device such as a microphone.

The output portion 95 includes a display device, such as a Liquid Crystal Display (LCD), an Electroluminescence (EL) panel, a Cathode Ray Tube (CRT) display, or a Plasma Display Panel (PDP), and an output device such as a printer. In addition, the output portion 95 may include a voice output device such as a speaker.

The communication controller 96 is connected to another device, and controls communication between the information processing device 90 and another device. For example, the communication controller 96 includes a Local Area Network (LAN) interface board, a wireless communication circuit for wireless communication, and a communication circuit for wired communication. The LAN interface board and the wireless communication circuit are connected to a network such as the Internet.

### First Operation Example

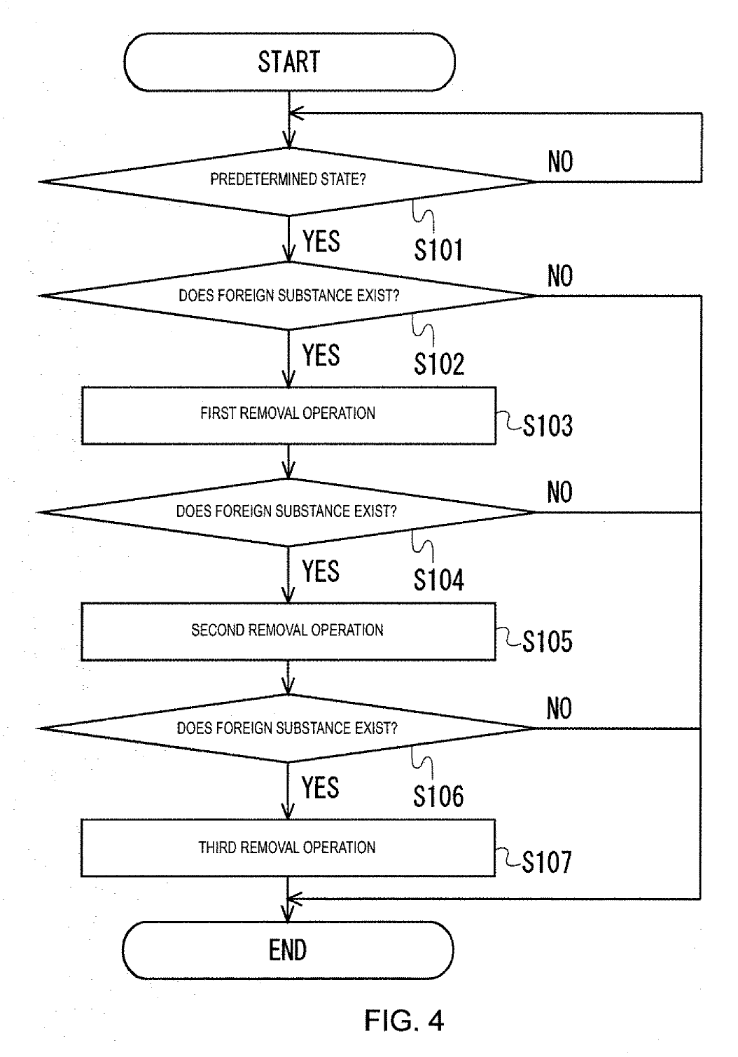

FIG. 4 is a flowchart illustrating a first example of flow of a foreign substance removal operation in the camera installed in the vehicle. The flow of the operation in FIG. 4 is flow of an operation performed in a case where electricity is supplied from the vehicle, on which the foreign substance removal control device 10 is mounted, to the foreign substance removal control device 10. In a case where a vehicle driving source is in an operating state, for example, in a case where an ignition switch is turned on if the driving source is an internal-combustion engine or in a case where system power is turned on if the driving source is a hybrid system or an Electric Vehicle (EV) system, the flow of the operation in FIG. 4 starts.

In S101, the controller 11 of the foreign substance removal control device 10 determines whether or not vehicle information acquired by the information acquisition portion 12 indicates a predetermined state. For example, the predetermined state includes a case where the shift lever 110 is at the “R (reverse)” position, a case where the radar ECU 120 detects a predetermined object, a case where the vehicle is driven, and other important cases. For example, the important cases include a case where there is a possibility that the vehicle transmits any information to the driver using the image captured by the camera 30. In a case where the vehicle information indicates the predetermined state (S101; YES), the process proceeds to S102. In a case where the vehicle information does not indicate the predetermined state (S101; NO), the process in S101 is repeated. The reason for this is that, in the case where the vehicle information does not indicate the predetermined state, foreign substance removal may not be performed.

In S102, the controller 11 of the foreign substance removal control device 10 instructs the image recognizer 13 to cause the camera 30 to capture an image. The image recognizer 13 causes the camera 30 to capture the image. The image captured by the camera 30 may be still images or moving images. The captured image may include a plurality of still images. The image recognizer 13 determines whether or not the foreign substance stuck on the lens exists in the image captured by the camera 30. The image recognizer 13 determines existence of the foreign substance using, for example, a well-known image recognition technology. In a case where the foreign substance exists on the lens of the camera 30 (S102; YES), the process proceeds to S103. In a case where the foreign substance does not exist on the lens of the camera 30 (S102; NO), the process ends.

In S103, the controller 11 of the foreign substance removal control device 10 instructs the blower controller 14 to cause the blower 40 to inject a first predetermined amount of the compressed air for a first predetermined period as a first removal operation. The blower controller 14 causes the blower 40 to inject the first predetermined amount of the compressed air for the first predetermined period. The blower 40 injects the first predetermined amount of the compressed air toward the camera 30 for the first predetermined period.

In S104, the controller 11 instructs the image recognizer 13 to cause the camera 30 to capture an image again. The image recognizer 13 causes the camera 30 to capture an image. The image captured by the camera 30 may be a still image or a moving image. The captured image may include a plurality of still images. The image recognizer 13 determines whether or not the foreign substance stuck on the lens exists in the image captured by the camera 30. That is, the image recognizer 13 determines whether or not the foreign substance detected in S102 is removed by the first removal operation. In the case where the foreign substance exists on the lens of the camera 30 (S104; YES), the process proceeds to S105. In a case where the foreign substance does not exist on the lens of the camera 30 (S104; NO), the process ends. Here, the detected foreign substance may be foreign substance that is in the same location as the foreign substance detected in S102 and that has the same type as the foreign substance. The reason for this is to perform a second removal operation in S105 in a case where the foreign substance detected in S102 is not removed in the first removal operation in S103.

In S105, the controller 11 instructs the blower controller 14 to cause the blower 40 to inject a second predetermined amount of the compressed air for a second predetermined period as the second removal operation. Here, the second predetermined amount is larger than the first predetermined amount, and the second predetermined period is longer than the first predetermined period. The blower controller 14 causes the blower 40 to inject the second predetermined amount of the compressed air for the second predetermined period.

The blower 40 injects the second predetermined amount of the compressed air toward the camera 30 for the second predetermined period. The second predetermined period may be equal to or shorter than the first predetermined period. In a case where more air is injected in a shorter time, it is possible to increase pressure of the injected compressed air. With the second removal operation, it is possible for the blower controller 14 to cause the compressed air to be strongly injected to the lens of the camera 30, compared to the first removal operation.

In S106, the controller 11 instructs the image recognizer 13 to cause the camera 30 to capture an image again. The image recognizer 13 causes the camera 30 to capture an image. The image captured by the camera 30 may be a still image or a moving image. The captured image may include a plurality of still images. The image recognizer 13 determines whether or not the foreign substance stuck on the lens exists in the image captured by the camera 30. That is, it is determined whether or not the foreign substance detected in S104 is removed through the second removal operation. In a case where the foreign substance exists on the lens of the camera 30 (S106; YES), the process proceeds to S107. In a case where the foreign substance does not exist on the lens of the camera 30 (S106; NO), the process ends. The foreign substance detected here may be foreign substance that is in the same location as the foreign substance detected in S104 and that has the same type as the foreign substance. In a case where the foreign substance detected in S104 is not removed in the second removal operation in S105, a third removal operation in S107 is performed.

In S107, the controller 11 instructs the washer controller 15 to inject a third predetermined amount of liquid (water or cleaning liquid) to the washer 50 for a third predetermined period as the third removal operation. The washer controller 15 causes the washer 50 to inject the third predetermined amount of the liquid for the third predetermined period. The washer 50 injects the third predetermined amount of the liquid to the camera 30 for the third predetermined period. The washer controller 15 is capable of performing a strong removal operation on the lens of the camera 30, compared to the first removal operation and the second removal operation.

Therefore, a series of removal operations end. The foreign substance removal control device 10 performs three types of removal operations according to a foreign substance removal situation in order to remove the foreign substance which is stuck on the lens of the camera 30. After ending the removal operations, the process may return to S101 again. Instead that the compressed air is injected from the blower 40, the liquid may be injected from the washer 50. Instead that the liquid is injected from the washer 50, the compressed air may be injected from the blower 40.

### First Modified Example

After the controller 11 causes the washer 50 to inject a fourth predetermined amount of liquid for a fourth predetermined period through the washer controller 15 and a fifth predetermined period elapses, the controller 11 may cause the blower 40 to inject a sixth predetermined amount of the compressed air for a sixth predetermined period through the blower controller 14 as the second removal operation or the third removal operation. Therefore, it is possible to more accurately perform foreign substance removal.

In a case where the controller 11 determines whether or not the foreign substance exists again after performing the third removal operation in S107 and the foreign substance still exists, the output device 20 may perform display which notifies a fact that it is not possible to remove the foreign substance. In addition, the controller 11 may cause the output device 20 to output voice and sound which indicates a fact that it is not possible to remove the foreign substance. Therefore, a driver of the vehicle is capable of recognizing that it is not possible to remove the foreign substance using the foreign substance removal operation and is capable of removing the foreign substance stuck on the camera 30 by himself or herself (using a towel) after stopping the vehicle in a safe location.

In a case where the blower 40 and the washer 50 do not exist in the vehicle and the foreign substance is detected through the process in S102 or the like, the controller 11 may cause the output device 20 to display a fact that the foreign substance exists on the lens of the camera 30. In addition, the controller 11 may cause the output device 20 to output voice and sound which indicates a fact that the foreign substance exists. Therefore, even though the blower 40 and the washer 50 do not exist in the vehicle, the driver of the vehicle is capable of recognizing the fact that the foreign substance exists on the lens of the camera 30 and is capable of removing the foreign substance stuck on the camera 30 by himself or herself (using a towel) after stopping the vehicle in the safe location. A notification that the foreign substance exists may be provided not only in a case where the foreign substance is stuck on but also in a case where the foreign substance exists for a predetermined time or more. In addition, the notification that the foreign substance exists may be provided through stronger attraction of attention (conspicuous warning display, high volume, or the like) in a case where a background image does not exists (spatial frequency is low) at a spot on which the foreign substance is stuck on.

The controller 11 may cause the blower 40 to inject the compressed air a predetermined number of times or may cause the washer 50 to inject the liquid a predetermined number of times as the first removal operation in S103. Furthermore, the controller 11 may determine existence of the foreign substance in S104 after a predetermined time elapses from the first removal operation. Here, in a case where the foreign substance still exists, the controller 11 may cause the output device 20 to display the fact that the foreign substance exists on the lens of the camera 30 or to output voice or the like. Therefore, in a case where the numbers of times the blower 40 and the washer 50 operate are reduced, it is possible to secure durability of the blower 40 and the washer 50.

The controller 11 may change the injection amount, the injection period, the number of injections, and the injection pressure of the compressed air and the liquid according to the type of the foreign substance in each removal operation. For example, the injection amount, the injection period, the number of injections, and the injection pressure are reduced in a case where the foreign substance is raindrops which are easily removed, and the injection amount, the injection period, the number of injections, and the injection pressure are increased in a case where the foreign substance is mud which is hardly removed.

The controller 11 may change the injection amount, the injection period, the number of injections, and the injection pressure of the compressed air and the liquid according to a purpose of the camera 30 in each removal operation. For example, in a case where the foreign substance is stuck on the camera 30 (for example, a camera used for sensing), in which high reliability is requested, the injection amount, the injection period, the number of injections, and the injection pressure are increased. Therefore, it becomes easy to remove the foreign substance on the camera 30 in which high reliability is requested.

In the operation in S101, the controller 11 may set the predetermined state to a case where the driver's sight line direction is a direction of the display (the car navigation system or the like) in the vehicle. That is, the controller 11 determines the predetermined state in a case where the driver's sight line direction, which is acquired by the information acquisition portion 12 from the interior camera 150, is the direction of the display. The reason for this is that, in a case where the driver's sight line direction is the direction of the display and the foreign substance is stuck on the lens of the camera 30, it is difficult for the driver to recognize the image captured by the camera 30.

While the driver's sight line direction is the direction of the display in the vehicle, the controller 11 may repeat determination of existence of the foreign substance (S102 or the like) and the foreign substance removal operation (S103 or the like) in the case where the foreign substance is stuck on.

In addition, in the operation in S101, the controller 11 may set the predetermined state to a case where the driver's sight line direction is not the direction of the display (the car navigation system or the like) in the vehicle. That is, the controller 11 determines the predetermined state in a case where the driver's sight line direction, which is acquired by the information acquisition portion 12 from the interior camera 150, is not the direction of the display. The reason for this is that it is not necessary to cause the driver to view the foreign substance removal operation performed on the lens of the camera 30 and the driver views the foreign substance removal operation in a case where the driver's sight line direction is the direction of the display and the foreign substance removal operation is performed on the lens of the camera 30.

The controller 11 may acquire information about the driver's sight line direction at every predetermined time. Here, the controller 11 may determine whether to detect the foreign substance (S101; YES) or not to detect the foreign substance (S101; NO) based on lastly acquired information about the driver's sight line. Therefore, even though the information about the driver's sight line direction is not continuously acquired, it is possible to continuously perform the foreign substance removal operation.

In a case where the plurality of cameras 30 exist in the vehicle and the foreign substance is detected in any one of the cameras 30, the controller 11 may perform the foreign substance removal operation on the whole cameras. The reason for this is that the foreign substance could be also stuck on another camera 30 in a case where the foreign substance is detected in one camera 30. In addition, the foreign substance removal operation performed by the blower 40 or the washer 50 generates motion sound. In a case where the foreign substance removal operations are simultaneously performed in the plurality of cameras 30, there is a problem in that a louder motion sound is generated. Therefore, it is possible to shift timings at which the foreign substance removal operations are performed in the respective cameras 30 such that the timings do not overlap. It is possible to suppress the motion sounds of the foreign substance removal operations due to the cameras 30.

### Second Operation Example

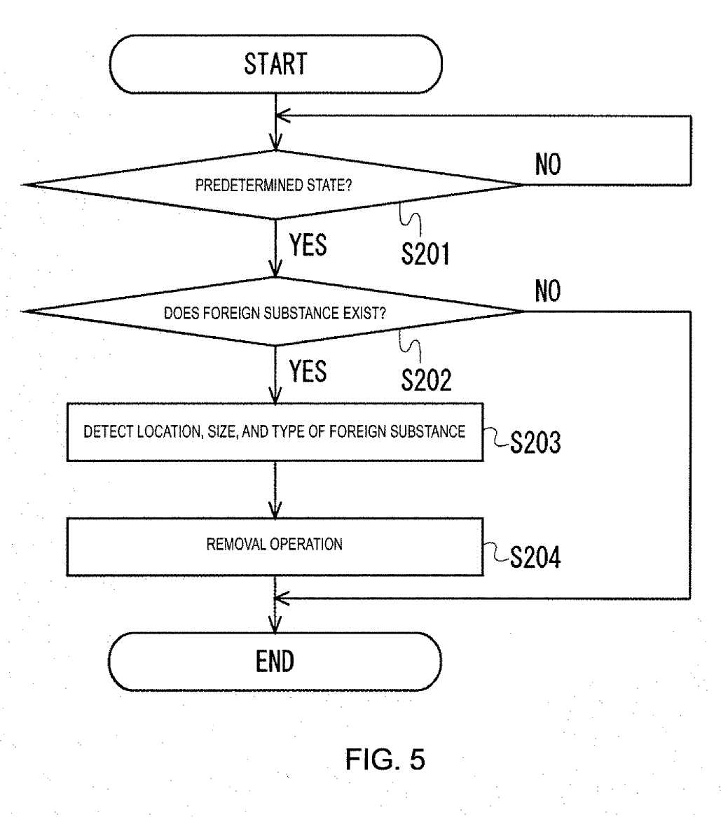

FIG. 5 is a flowchart illustrating a second example of flow of the foreign substance removal operation in the camera installed in the vehicle. The flow of the operation of FIG. 5 is a flow of an operation performed in a case where electricity is supplied from the vehicle, on which the foreign substance removal control device 10 is mounted, to the foreign substance removal control device 10. The flow of the operation of FIG. 5 starts in a case where a driving source of the vehicle is in an operating state, for example, in a case where an ignition switch is turned on if the driving source is an internal-combustion engine and in a case where a system power is turned on if the driving source is a hybrid system or an EV system. Here, the foreign substance removal operation is changed based on a location, a size, and a type of the foreign substance.

In S201, the controller 11 of the foreign substance removal control device 10 determines whether or not the vehicle information acquired by the information acquisition portion 12 indicates the predetermined state. The operation in S201 is the same as the operation in S101 of FIG. 4.

In S202, the controller 11 of the foreign substance removal control device 10 determines whether or not the foreign substance stuck on the lens of the camera 30 exists through the image recognizer 13. The operation in S202 is the same as the operation in S102 of FIG. 4.

In S203, the image recognizer 13 of the foreign substance removal control device 10 detects the location, the size, and the type of the foreign substance detected in S102 in the image captured by the camera 30. The image recognizer 13 detects at least one of the location, the size, and the type of the foreign substance. The image recognizer 13 is capable of detecting the location, the size, and the type of the foreign substance using a well-known image recognition method. For example, the location of the foreign substance in the image is indicated by coordinates of the foreign substance in the image. In addition, since the locations of the injection nozzles of the blower 40 and the washer 50 are known, a distance between the foreign substance and the injection nozzles are easily acquired based on the coordinates of the foreign substance and the locations of the injection nozzles. In addition, the size of the foreign substance is displayed based on a ratio of pixels corresponding to the foreign substance to the image, the number of pixels, an area of the foreign substance, and the like. It is possible to distinguish the type of the foreign substance using the well-known image recognition method. For example, the type of the foreign substance is distinguished by a color or the like of the foreign substance. The type of the foreign substance includes raindrops, mud, snow, and the like.

In S204, the controller 11 of the foreign substance removal control device 10 instructs the blower controller 14 or the washer controller 15 to cause the blower 40 or the washer 50 to inject a predetermined amount of the compressed air or the liquid at a predetermined injection pressure for a predetermined period, a predetermined number of times, as the foreign substance removal operation. The controller 11 determines the predetermined amount, the predetermined period, the predetermined number of times, and the predetermined injection pressure based on at least one of the distance between the foreign substance and the injection nozzles, the size of the foreign substance, and the type of the foreign substance. The controller 11 causes the injection amount, the injection period, the number of injections, and an injection pressure to be large as the distance between the foreign substance and the injection nozzle is long. The controller 11 causes the injection amount, the injection period, the number of injections, and the injection pressure to be large as the size of the foreign substance is large. The controller 11 causes the injection amount, the injection period, the number of times of injection, and the injection pressure to be large as the type of the foreign substance corresponds to a type which is easily stuck to the lens. For example, the controller 11 determines the substance to be hardly stuck in a case where the type of the foreign substance is raindrops, and determines the substance to be easily stuck in a case where the type of the foreign substance is mud.

Therefore, a series of removal operations end. The foreign substance removal control device 10 performs the removal operation according to a foreign substance state in order to remove the foreign substance, which is stuck on the lens of the camera 30. After the removal operation ends, the process may return to S201 again. Therefore, it is possible to perform the foreign substance removal operation according to a foreign substance situation.

### Second Modified Example

In the foreign substance removal operation in S204, the controller 11 may sequentially reduce the injection amount as the number of times the compressed air and the liquid are injected becomes large. Here, it is possible to save the injection amount of the compressed air and liquid.

Similar to the example of FIG. 4, the controller 11 may repeat the foreign substance detection (S202) and the foreign substance removal operation (S204) a plurality of times. Here, the controller 11 may detect the location, the size, and the type of the foreign substance (S203) after the foreign substance detection (S202). In addition, the controller 11 may perform the second removal operation in a case where the size of the foreign substance detected for the second time is 10% or more of the size of the foreign substance detected for the first time, and the controller 11 may perform a third removal operation in a case where the size of the foreign substance detected for the third time is 5% or more of the size of the size of the foreign substance detected for the first time. Therefore, in a case where more than 90% of the foreign substance detected for the first time is removed, the removal operations subsequent to the second removal operation are not performed. In a case where more than 95% of the foreign substance detected for the first time is removed, the removal operations subsequent to the third removal operation are not performed.

In addition, in a case where the location of the foreign substance detected for the second time is included in a first distance area from a center of the image, the controller 11 may perform the second removal operation. In a case where the location of the foreign substance detected for the third time is included in a second distance area, which is shorter than the first distance, from the center of the image, the controller 11 may perform the third removal operation. Therefore, in a case where the foreign substance does not exist in the first distance area from the center of the image, the removal operations subsequent to the second removal operation are not performed. In a case where the foreign substance does not exist in the second distance area from the center of the image, the third removal operation is not performed. It is considered that a central part of the image is more important than a peripheral part of the image. Therefore, in a case where the foreign substance at the central part of the image is not removed, the foreign substance removal operation repeatedly performed. Therefore, the foreign substance removal operation is performed on the central part of the image as priority.

In a case where external temperature of the vehicle is equal to or lower than a predetermined value (for example, 0 degrees Celsius or lower), the controller 11 may reduce the injection amount in the foreign substance removal operation. In addition, in a case where the detected foreign substance is predetermined snow (for example, powder snow), the controller 11 may reduce the injection amount in the foreign substance removal operation. The reason for this is that the compressed air and the liquid could be frozen. For example, the powder snow is snow which falls at a temperature of −5 degrees Celsius or lower. The external temperature (air temperature) of the vehicle may be acquired by a temperature sensor that is installed on the vehicle in advance.

### Third Operation Example

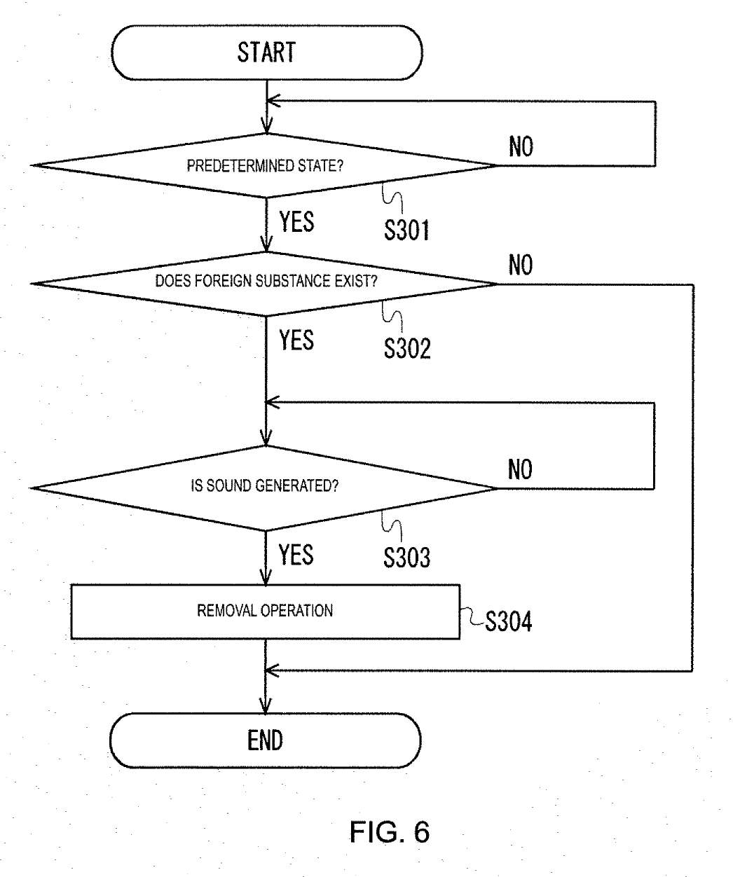

FIG. 6 is a flowchart illustrating a third example of flow of the foreign substance removal operation in the camera installed in the vehicle. The flow of the operation of FIG. 6 is a flow of an operation performed in a case where electricity is supplied from the vehicle, on which the foreign substance removal control device 10 is mounted, to the foreign substance removal control device 10. The flow of the operation of FIG. 6 starts in a case where the driving source of the vehicle is in the operating state, for example, in a case where the ignition switch is turned on if the driving source is the internal-combustion engine and in a case where the system power is turned on if the driving source is the hybrid system and the EV system. Here, the foreign substance removal operation is performed in a case where another sound is generated.

In S301, the controller 11 of the foreign substance removal control device 10 determines whether or not the vehicle information acquired by the information acquisition portion 12 indicates the predetermined state. The operation in S301 is the same as the operation in S101 of FIG. 4.

In S302, the controller 11 of the foreign substance removal control device 10 determines whether or not the foreign substance stuck on the lens of the camera 30 exists through the image recognizer 13. The operation in S302 is the same as the operation in S102 of FIG. 4.

In S303, the controller 11 determines whether or not an operation of generating sound is performed from the vehicle information acquired by the information acquisition portion 12. In a case where the operation of generating sound is performed (S303; YES), the process proceeds to S304. In a case where the operation of generating sound is not performed (S303; NO), the process in S303 is repeated. Examples of the operation of generating sound include an operation of setting the shift lever 110 to the “R (reverse)” position where back warning sound is generated, and an operation of pressing a horn button which causes horn sound to be generated. The operation of generating sound may include a case where a noise level on the outside or the inside of the vehicle is equal to or higher than a predetermined value. The noise level is acquired by an input part, such as a microphone, which is installed on the outside or the inside of the vehicle through the information acquisition portion 12.

In S304, the controller 11 of the foreign substance removal control device 10 instructs the blower controller 14 or the washer controller 15 to cause the blower 40 or the washer 50 to inject the predetermined amount of the compressed air or the liquid at the predetermined injection pressure for the predetermined period the predetermined number of times as the foreign substance removal operation. The foreign substance removal operation is performed in accordance with the operation of generating sound in S303. In a case where the foreign substance removal operation is performed in accordance with the operation of generating sound, it is possible to ignore sound generated due to the foreign substance removal operation. The controller 11 of the foreign substance removal control device 10 may increase the injection amount of the compressed air and the liquid to be more than normal.

Therefore, the foreign substance removal control device 10 is capable of mixing sound generated due to the foreign substance removal operation with sound generated due to another operation.

The Others

In a case where a manual operation, that is, a predetermined operation is performed by the vehicle's driver or the like, the foreign substance removal control device 10 may perform the removal process by controlling any one of the predetermined amount, the predetermined period, the predetermined number of times, and the predetermined pressure of the injected air or the liquid, as described above. Meanwhile, the foreign substance removal control device 10 may perform the removal process in a case where the manual operation is performed by the vehicle's driver and the foreign substance stuck on the lens is detected through image recognition.

In a case where the manual operation is sequentially performed for the predetermined period, the foreign substance removal control device 10 may change the predetermined amount, the predetermined period, the predetermined number of times, and the predetermined pressure of the injected air or the liquid according to the number of times. For example, as the number of times the manual operation is performed increases, the predetermined amount, the period, the number of times, and pressure of the injected air or the liquid increase. Meanwhile, the foreign substance removal control device 10 may cause a first manual operation, that is, a manual operation performed after a predetermined period or more elapses from a previous manual operation to have the same predetermined amount, predetermined period, predetermined number of times, and predetermined pressure of the injected air or the liquid in a first automatic removal process.

Computer-Readable Recording Medium

It is possible to record a program which causes a computer and other mechanical devices (hereinafter, referred to as a computer and the like) to realize any one of the above-described functions in a computer-readable recording medium. Furthermore, it is possible to provide the function by causing the computer and the like to read and execute the program of the recording medium.

Here, the computer-readable recording medium refers to a recording medium which accumulates information, such as data and a program, through an electrical, magnetic, optical, mechanical, or chemical operation, and allows the computer and the like to read the information. In such a recording medium, elements, such as a CPU and a memory, which form the computer, are provided, and the CPU may be caused to execute the program.

In addition, a recording medium which is detachable from the computer and the like includes, for example, a flexible disk, a magneto-optical disk, a CD-ROM, a CD-R/W, a DVD, a DAT, a 8 mm tape, a memory card, and the like.

In addition, a recording medium which is fixed to the computer and the like includes a hard disk, a ROM, and the like.

While the invention has been shown and described in detail, the foregoing description is in all aspects illustrative and not restrictive. It is therefore understood that numerous other modifications and variations can be devised without departing from the scope of the invention.

What is claimed is:

1. A foreign substance removal control device comprising:
an image recognizer having a processor and that detects foreign substance stuck on a lens of a camera based on an image captured by the camera;
an injector that injects air or liquid to the lens of the camera;
an output portion that outputs information to a user; and
a controller that controls a foreign substance removal process for removing the foreign substance from the lens of the camera by causing the injector to inject the air or the liquid in a case where the image recognizer detects the foreign substance stuck on the lens of the camera,
wherein the controller causes the output portion to output information which indicates that the foreign substance is stuck on the lens of the camera in a case where the image recognizer detects the foreign substance stuck on the lens of the camera after the foreign substance removal process has been performed.

2. The foreign substance removal control device according to claim 1,
wherein the output portion includes a display that outputs the information as a message.

3. The foreign substance removal control device according to claim 1,
wherein the output portion includes a speaker that outputs the information as sound.

4. The foreign substance removal control device according to claim 1,
wherein the foreign substance detected to be stuck on the lens of the camera after the foreign substance removal process has been performed is at a same location as the foreign substance detected to be stuck on the lens of the camera before the foreign substance removal process was performed.

5. A foreign substance removal control device comprising:
an image recognizer having a processor and that detects foreign substance stuck on lenses of a plurality of cameras based on images captured by the plurality of cameras which are mounted on a vehicle;
injectors that are provided to each of the plurality of cameras, and that inject air or liquid to the lenses of the plurality of cameras;
an output portion that outputs information to a user; and
a controller that controls a foreign substance removal process for removing the foreign substance from the lenses of the cameras by causing the injectors of the plurality of cameras to inject the air or the liquid in a case where the image recognizer detects the foreign substance stuck on the lenses of the plurality of cameras,
wherein the controller causes the output portion to output information which indicates that the foreign substance is stuck on the lenses of the plurality of cameras in a case where the image recognizer detects the foreign substance stuck on the lenses of the plurality of cameras after the foreign substance removal process has been performed.

6. The foreign substance removal control device according to claim 5,
wherein the controller controls the foreign substance removal process for removing the foreign substance by causing all of the injectors of the plurality of cameras to inject the air or the liquid in a case where the image recognizer detects the foreign substance stuck on the lenses of at least one of the plurality of cameras.

7. The foreign substance removal control device according to claim 5,
wherein the controller controls the foreign substance removal process for removing the foreign substance by causing the injectors of each of the plurality of cameras to inject the air or the liquid at different timings.

8. The foreign substance removal control device according to claim 5,
wherein the output portion includes a display that outputs the information as a message.

9. The foreign substance removal control device according to claim 5,
wherein the output portion includes a speaker that outputs the information as sound.

10. The foreign substance removal control device according to claim 5,
wherein the foreign substance detected to be stuck on the lenses of the cameras after the foreign substance removal process has been performed is at a same location as the foreign substance detected to be stuck on the lenses of the cameras before the foreign substance removal process was performed.

11. A foreign substance removal control method comprising the steps of:
detecting, by an image recognizer having a processor, foreign substance stuck on a lens of a camera based on an image captured by the camera;
performing a foreign substance removal process for removing the foreign substance by injecting air or liquid from an injector to the lens of the camera; and
outputting information which indicates that the foreign substance is stuck on the lens of the camera to a user in a case where the foreign substance stuck on the lens of the camera is detected after the foreign substance removal process has been performed.

12. The foreign substance removal control method according to claim 11,
wherein the outputting includes outputting the information as a message on a display.

13. The foreign substance removal control method according to claim 11,
wherein the outputting includes outputting the information as sound via a speaker.

14. The foreign substance removal control method according to claim 11,
wherein the foreign substance detected to be stuck on the lens of the camera after the foreign substance removal process has been performed is at a same location as the foreign substance detected to be stuck on the lens of the camera before the foreign substance removal process was performed.
